(19) United States
(12) Patent Application Publication
(10) Pub. No.: US 2002/0158444 A1
(43) Pub. Date: Oct. 31, 2002

(54) Telescoping coupling device for two strollers

(76) Inventor: Lisa DeTournay, Coral Gables, FL (US)

Correspondence Address: Richard W. Goldstein, 2071 Clove Road, Staten Island, NY, 10304, US

(21) Appl. No.: 09/844,600

(22) Filed: Apr. 27, 2001

(51) Int. Cl. B60D 1/00

(52) U.S. Cl. 280/491.2; 280/477

(57) ABSTRACT

A telescoping coupling device for two strollers including a cylindrical member having an open first end, a closed second end and a hollow interior. The closed second end has a fixed arm extending outwardly therefrom. The fixed arm has a U-shaped bracket secured thereto. The bracket receives a frame of the first stroller therebetween. A telescoping arm is slidably received within the open first end of the cylindrical member. The telescoping arm has an inner segment, an outer segment, and an intermediate segment therebetween. The inner segment is received within the open first end of the cylindrical member. The outer segment has an arm extending outwardly therefrom in a co-linear orientation. The arm has a U-shaped bracket secured thereto. The bracket receives a frame of the second stroller therebetween.

### BACKGROUND OF THE INVENTION

The present invention relates to a telescoping coupling device for two strollers and more particularly pertains to allowing two strollers to be coupled at a variety of distances.

The use of multiple stroller joining devices is known in the prior art. More specifically, multiple stroller joining devices heretofore devised and utilized for the purpose of joining strollers together are known to consist basically of familiar, expected and obvious structural configurations, notwithstanding the myriad of designs encompassed by the crowded prior art that have been developed for the fulfillment of countless objectives and requirements.

By way of example, U.S. Pat. No. 5,918,892 to Aaron discloses a device for connecting two or more strollers using a device comprised of two jaws capable of rotating and connecting with a spring clamp assembly. U.S. Pat. No. 4,808,938 to Redmond discloses a device for connecting strollers comprised of a pair of brackets bolted to a housing. U.S. Pat. No. 5,522,121 to Fraynd discloses a coupler for two strollers comprised of a snap release connector.

While these devices fulfill their respective, particular objective and requirements, the aforementioned patents do not describe a telescoping coupling device for two strollers for allowing two strollers to be coupled at a variety of distances.

In this respect, the telescoping coupling device for two strollers according to the present invention substantially departs from the conventional concepts and designs of the prior art, and in doing so provides an apparatus primarily developed for the purpose of allowing two strollers to be coupled at a variety of distances.

Therefore, it can be appreciated that there exists a continuing need for a new and improved telescoping coupling device for two strollers that can be used for allowing two strollers to be coupled at a variety of distances. In this regard, the present invention substantially fulfills this need.

### SUMMARY OF THE INVENTION

In the view of the foregoing disadvantages inherent in the known types of multiple stroller joining devices now present in the prior art, the present invention provides an improved telescoping coupling device for two strollers. As such, the general purpose of the present invention, which will be described subsequently in greater detail, is to provide a new and improved telescoping coupling device for two strollers that has all the advantages of the prior art and none of the disadvantages.

To attain this, the present invention essentially comprises a cylindrical member having an open first end, a closed second end and a hollow interior. The closed second end has a fixed arm extending outwardly therefrom. The fixed arm has a U-shaped bracket secured thereto. The bracket is defined by opposed free ends. The opposed free ends receive a frame of the first stroller therebetween. The opposed free ends have couplable straps secured thereto for mating togther to contain the frame of the first stroller therebetween. The cylindrical member has a plurality of linearly aligned aperture's therethrough inwardly of the open first end. A telescoping arm is slidably received within the open first end of the cylindrical member. The telescoping arm has an inner segment, an outer segment, and an intermediate segment therebetween. The inner segment is received within the open first end of the cylindrical member. The inner segment has a spring-biased detent extending outwardly therefrom for being selectively received within one of the linearly aligned apertures of the cylindrical member. The outer segment has an arm extending outwardly therefrom in a co-linear orientation. The arm has a U-shaped bracket secured thereto. The bracket is defined by opposed free ends. The opposed free ends receive a frame of the second stroller therebetween. The opposed free ends have couplable straps secured thereto for mating togther to contain the frame of the second stroller therebetween.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved telescoping coupling device for two strollers that has all the advantages of the prior art multiple stroller joining devices and none of the disadvantages.

It is another object of the present invention to provide a new and improved telescoping coupling device for two strollers that may be easily and efficiently manufactured and marketed.

It is a further object of the present invention to provide a new and improved telescoping coupling device for two strollers that is of durable and reliable construction.

An even further object of the present invention is to provide a new and improved telescoping coupling device for two strollers that is susceptible of a low cost of manufacture with regard to both materials and labor, and which accordingly is then susceptible of low prices of sale to the consuming public, thereby making such a telescoping coupling device for two strollers economically available to the buying public.

Even still another object of the present invention is to provide a new and improved telescoping coupling device for two strollers for allowing two strollers to be coupled at a variety of distances.

Lastly, it is an object of the present invention to provide a new and improved telescoping coupling device for two strollers including a cylindrical member having an open first end, a closed second end and a hollow interior. The closed second end has a fixed arm extending outwardly therefrom. The fixed arm has a U-shaped bracket secured thereto. The bracket is defined by opposed free ends. The opposed free ends receive a frame of the first stroller therebetween. The cylindrical member has a plurality of linearly aligned aperture's therethrough inwardly of the open first end. A telescoping arm is slidably received within the open first end of the cylindrical member. The telescoping arm has an inner segment, an outer segment, and an intermediate segment therebetween. The inner segment is received within the open first end of the cylindrical member. The inner segment has a spring-biased detent extending outwardly therefrom for being selectively received within one of the linearly aligned apertures of the cylindrical member. The outer segment has an arm extending outwardly therefrom in a co-linear orientation. The arm has a U-shaped bracket secured thereto. The bracket is defined by opposed free ends. The opposed free ends receive a frame of the second stroller therebetween.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the telescoping coupling device for two strollers constructed in accordance with the principles of the present invention.

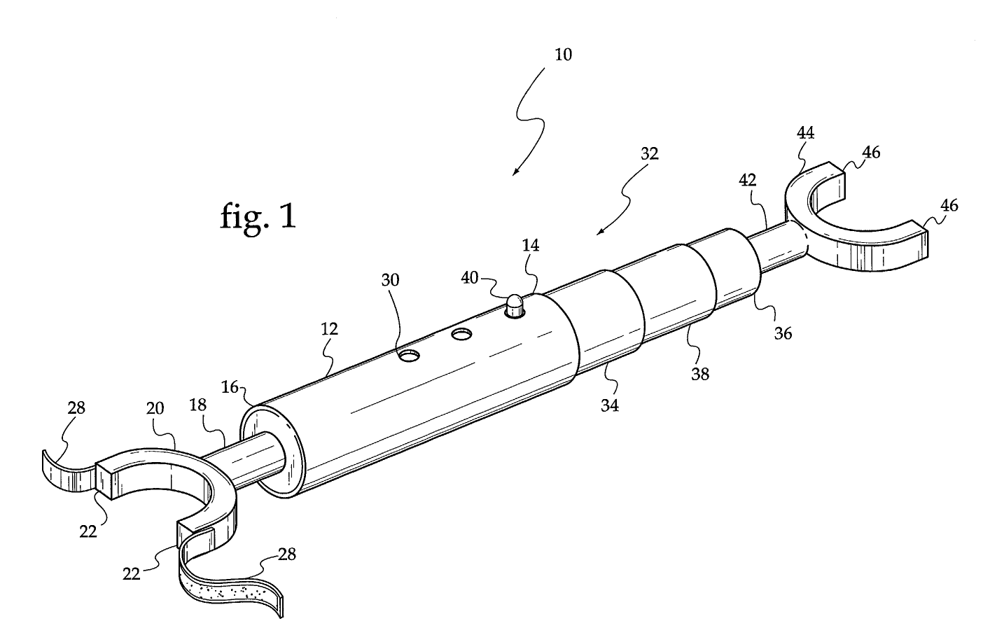

FIG. 2 is a perspective view of the present invention illustrated in use.

The same reference numerals refer to the same parts through the various figures.

### DESCRIPTION OF THE PREFERRED EMBODIMENT

With reference now to the drawings, and in particular, to figures one through two thereof, the preferred embodiment of the new and improved telescoping coupling device for two strollers embodying the principles and concepts of the present invention and generally designated by the reference number 10 will be described.

Specifically, it will be noted in the various figures that the device relates to a telescoping coupling device for two strollers for allowing two strollers to be coupled at a variety of distances. In its broadest context, the device consists of a cylindrical member and a telescoping arm. Such components are individually configured and correlated with respect to each other so as to attain the desired objective.

The cylindrical member 12 has an open first end 14, a closed second end 16 and a hollow interior. The closed second end 16 has a fixed arm 18 extending outwardly therefrom. The fixed arm 18 has a U-shaped bracket 20 secured thereto. The bracket 20 is defined by opposed free ends 22. The opposed free ends 22 receive a frame 24 of the first stroller 26 therebetween. The opposed free ends 22 have couplable straps 28 secured thereto for mating togther to contain the frame 24 of the first stroller 26 therebetween. The straps 28 preferably utilize hook and loops to facilitate coupling. The cylindrical member 12 has a plurality of linearly aligned apertures 30 therethrough inwardly of the open first end 14.

The telescoping arm 32 is slidably received within the open first end 14 of the cylindrical member 12. The telescoping arm 32 has an inner segment 34, an outer segment 36, and an intermediate segment 38 therebetween. The inner segment 34 is received within the open first end 14 of the cylindrical member 12. The inner segment 34 has a spring-biased detent 40 extending outwardly therefrom for being selectively received within one of the linearly aligned apertures 30 of the cylindrical member 12. The outer segment 36 has an arm 42 extending outwardly therefrom in a co-linear orientation. The arm 42 has a U-shaped bracket 44 secured thereto. The bracket 44 is defined by opposed free ends 46. The opposed free ends 46 receive a frame 48 of the second stroller 50 therebetween. The opposed free ends 46 have couplable straps 52 secured thereto for mating togther to contain the frame 48 of the second stroller 50 therebetween. The telescoping arm 32 can be adjusted in length to allow a desired distance between the strollers 26,50 to be reached.

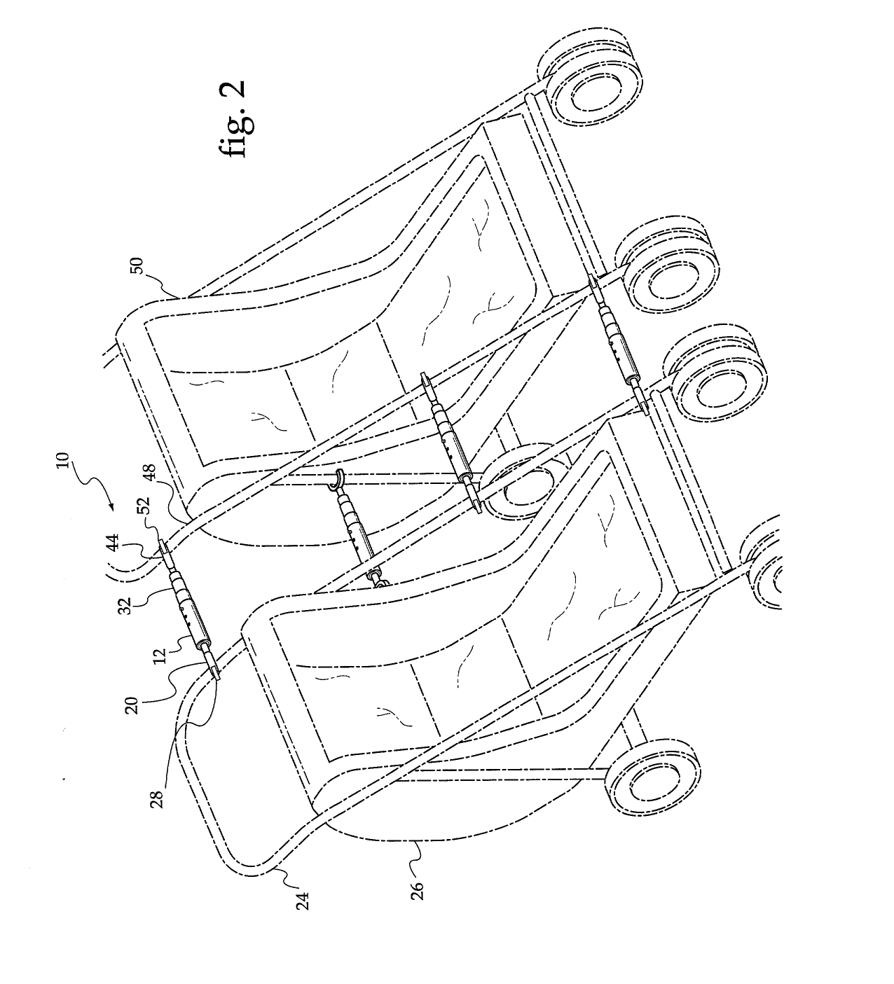

In use, the present invention will extend between the first and second strollers 26,50 to allow a single person to safely maneuver the strollers 26,50 around. It should be noted, as illustrated in FIG. 2, that multiple devices 10 will ordinarily be used in order to couple the strollers 26,50 together. Additionally, the present invention could be used to secure more than two strollers together.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A telescoping coupling device for two strollers for allowing two strollers to be coupled at a variety of distances, the two strollers including a first stroller and a second stroller, the coupling device comprising, in combination:
a cylindrical member having an open first end, a closed second end and a hollow interior, the closed second end having a fixed arm extending outwardly therefrom, the fixed arm having a U-shaped bracket secured thereto, the bracket being defined by opposed free ends, the opposed free ends receiving a frame of the first stroller therebetween, the opposed free ends having couplable straps secured thereto for mating togther to contain the frame of the first stroller therebetween, the cylindrical member having a plurality of linearly aligned aperture's therethrough inwardly of the open first end; and
a telescoping arm slidably received within the open first end of the cylindrical member, the telescoping arm having an inner segment, an outer segment, and an intermediate segment therebetween, the inner segment being received within the open first end of the cylindrical member, the inner segment having a spring-biased detent extending outwardly therefrom for being selectively received within one of the linearly aligned apertures of the cylindrical member, the outer segment having an arm extending outwardly therefrom in a co-linear orientation, the arm having a U-shaped bracket secured thereto, the bracket being defined by opposed free ends, the opposed free ends receiving a frame of the second stroller therebetween, the opposed free ends having couplable straps secured thereto for mating togther to contain the frame of the second stroller therebetween.

2. A telescoping coupling device for at least two strollers for allowing al least two strollers to be coupled at a variety of distances, the strollers including at least a first stroller and a second stroller, the coupling device comprising, in combination:
a cylindrical member having an open first end, a closed second end and a hollow interior, the closed second end having a fixed arm extending outwardly therefrom, the fixed arm having a U-shaped bracket secured thereto, the bracket being defined by opposed free ends, the opposed free ends receiving a frame of the first stroller therebetween, the cylindrical member having a plurality of linearly aligned aperture's therethrough inwardly of the open first end; and
a telescoping arm slidably received within the open first end of the cylindrical member, the telescoping arm having an inner segment, an outer segment, and an intermediate segment therebetween, the inner segment being received within the open first end of the cylindrical member, the inner segment having a spring-biased detent extending outwardly therefrom for being selectively received within one of the linearly aligned apertures of the cylindrical member, the outer segment having an arm extending outwardly therefrom in a co-linear orientation, the arm having a U-shaped bracket secured thereto, the bracket being defined by opposed free ends, the opposed free ends receiving a frame of the second stroller therebetween.

3. The telescoping coupling device as set forth in claim 2 wherein the opposed free ends of the brackets of the cylindrical member and the telescoping arm each have couplable straps secured thereto for mating togther to contain the frames of the first stroller and second stroller therebetween.
